(19) United States
(12) Patent Application Publication
(10) Pub. No.: US 2002/0187368 A1
(43) Pub. Date: Dec. 12, 2002

(54) Magnetic recording medium and a method of manufacture thereof

(76) Inventors: Yuuji Senzaki, Miyagi (JP); Hiroshi Uchiyama, Miyagi (JP); Takahiro Igari, Miyagi (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/133,807

(22) Filed: Apr. 26, 2002

(30) Foreign Application Priority Data
May 14, 2001 (JP) P2001-143566

(51) Int. Cl. G11B 5/65

(52) U.S. Cl. 428/694 T

(57) ABSTRACT

A magnetic recording medium having a high coercive force and a high signal to noise ratio suitable for use in a high density recording, and a method of manufacture thereof are provided, by using a resin substrate capable of processing approximately at room temperatures. A magnetic film mainly comprising Co—Pt—Cr and including a silicon oxide is formed on the resin substrate wherein an amount of silicon element constituting the silicon oxide in terms of atomic percent relative to the Co—Pt—Cr is 8 atomic % or more and 16 atomic % or less, thereby efficiently decreasing the inter-crystal interaction between crystal grains therein. Further, the magnetic film is formed on the substrate made of the resin in the non-heated state by sputtering in a sputtering chamber at a gas pressure of 0.133 Pa or more and 2.66 Pa or less.

### CROSS REFERENCES TO RELATED APPLICATIONS

The present document is based on Japanese Priority Document JP 2001-143566, filed in the Japanese Patent Office on May 14, 2001, the entire contents of which being incorporated herein by reference.

### BACKGROUND OF THE INVENTION

1. Field of the Invention

The present invention relates to a magnetic recording medium having a magnetic layer formed on a substrate by sputtering, and a method of manufacturing the same.

2. Description of the Related Art

As an external storage device for use of a computer and the like, there is used widely a so-called magnetic disk drive comprising a magnetic disk having its magnetic layer formed on a substrate such as an aluminum base plate, glass or the like and a magnetic head mounted on a slider. In this magnetic disk drive, the magnetic head operates in a state facing the surface of the magnetic disk and floating at a minute distance therefrom, to record and reproduce a signal to and from the magnetic disk.

A demand for a higher density recording is increasing for the magnetic disk drive in line with the recent trend of providing multiple functions and improved performance to the computer. As an approach to realize the higher density recording in the magnetic disk drive, it is attempted to minimize a floating gap between the magnetic head and the magnetic disk.

In the magnetic disk drive, the slider on which the magnetic head is mounted is kept floating over the surface of the magnetic disk at a distance, for example, approximately of 20 nm while recording and/or reproducing a signal. During this operation, presence of any bump or protrusion on the surface of the magnetic disk exceeding a peak height of 20 nm may cause a problem of crash of a magnetic head. Therefore, such a stringent surface flatness or smoothness is required that any peaking height present on the surface thereof should be less than 20 nm.

Conventionally, in a case where an aluminum substrate is used, a protrusion or bump having a peaking height in excess of 15 nm is removed by the following method in order to obtain a flat and smooth disk surface. This method is comprised of the steps of: cutting a metallic material such as aluminum into a form of the substrate; and sufficiently polishing this cut-out aluminum substrate so as to remove any protrusion in excess of 15 nm, which may cause a crash of the magnetic head, from the surface of the aluminum substrate. More specifically, in order to provide an enhanced smoothness in the surface of the aluminum substrate, the polishing and cleaning of the aluminum substrate are repeated with a grain size of grinder particles used for the polishing being reduced every time the polishing is repeated, thereby sufficiently removing the protrusion having a peaking height in excess of 15 nm. These steps are also applied to a case where a glass substrate is used, and where a smooth surface thereof is obtained by repeating the polishing and cleaning likewise in the case of the aluminum substrate.

However, in these cases where the aluminum or glass substrates are used, because of very complicated and troublesome processes of polishing and cleaning required for obtaining the smooth surface of these substrates, there is such a problem that a manufacturing cost increases thereby resulting in an increased price of the magnetic disk itself.

Therefore, in order to solve the aforementioned problem associated with the metallic or glass substrates, a plastic substrate (made of resin) is proposed as a substrate for use in the magnetic disk. In a case of a resin substrate, as it is manufactured by injection molding or the like, a surface coarseness or roughness of its surface is determined corresponding to a surface coarseness or roughness of a die or a master stamper to be used in this injection molding. Thereby, using a die or stamper with a precisely polished surface to have an improved flatness, it is enabled to manufacture a resin substrate having an excellent smoothness of surface free from any bumps or protrusions that may cause the problem. Thereby, by adopting the resin substrate, extra processing such as polishing, cleaning and the like required for the aluminum or glass substrates is no more required, thereby simplifying the steps in the manufacture of the magnetic disk, and reducing the manufacturing cost thereof.

Generally, in the manufacture of the magnetic disk, a magnetic thin film layer consisting, for example, of a cobalt alloy is formed on a substrate by sputtering while heating the substrate approximately to 200° C. or more.

In the sputtering method, when the temperature of the substrate is high, a kinetic energy exerted until atoms flown onto the surface of the substrate are densely packed with their crystalline axes aligned becomes greater than that exerted when the temperature thereof is low. Therefore, by heating the substrate, magnetic properties of the cobalt alloy thin film, in particular, a coercive force Hc thereof can be increased.

However, in the case of the resin substrate, because its glass transition temperature is low, it is not possible to heat the resin substrate as high as 200° C. or more at the time of forming the magnetic layer thereon. Because of such a constraint imposed thereon, there has been such a problem that the coercive force Ha of the magnetic disk using the resin substrate is inevitably small.

Therefore, in order to be able to use the resin substrate in the magnetic disk, it has been desired that a sufficient magnetic property required for a satisfactory magnetic recording medium can be provided while allowing for the resin substrate to be processed at room temperatures at the time of forming its magnetic layer.

In the field of the magnetic recording, at the same time with an increasing demand for the high density recording, the signal mode is changing from analog to digital modes. Therefore, it is also becoming important to consider an appropriate medium design that matches such the signal mode in addition to the high density recording. Further, there are many other factors to be considered in the design steps of the magnetic recording medium depending on various properties of the magnetic head to be used in recording and/or reproducing information.

Among these factors to be considered depending on the magnetic properties of the magnetic recording medium, there is a residual magnetization thickness which is controlled and determined by a reproducing capability of a reproducing magnetic head. This residual magnetization thickness of the magnetic layer is expressed by a product Mr·t between a residual magnetization Mr of the magnetic layer and a thickness t of the magnetic layer. This residual magnetization thickness needs to be set at a value in such a range that its reproduced output becomes large enough against a noise so that the noise in a magnetic head amplifier becomes negligible. This value is determined by a reproducing sensitivity and a saturation flux of the magnetic head.

Further, among the magnetic properties of the magnetic recording medium, such one that is to be limited by a writing capability of the recording magnetic head is a coercive force. A maximum value of its coercive force is determined from the viewpoint that the coercive force of the magnetic layer should be preferably within a range of the writing capability of the recording magnetic head.

Still further, in order to realize the high density recording (in particular, a high density linear recording), it is necessary to increase its resolution capability and to ensure for a reproduction output of high frequency signals not to decrease. As an index for indicating the resolution capability, a ratio of the residual magnetization thickness to the coercive force (Mr·t/Hc) is used. The smaller this value becomes, the more the resolution capability increases and the more the frequency characteristics improve. Therefore, from the viewpoint for increasing the resolution capability, it is necessary to increase the coercive force and to decrease the residual magnetization thickness.

Furthermore, research and development of the high density recording is gaining leverage not only in the magnetic recording medium but also in the field of the magnetic heads for use in reproducing information. Among them, in particular, a magnetic resistive effect (magneto-resistive) type magnetic head, because it has a higher sensitivity in comparison with that of the conventional thin film head, can sense an extremely weak signal, however, it is likely to sense a noise as well. Therefore, in line with an increasing demand for a further improvement in the performance of the magnetic head, it is becoming vital to be able to reduce a noise level in the magnetic recording medium, namely, to obtain a higher signal to noise ratio.

### SUMMARY OF THE INVENTION

The present invention has been contemplated to solve the aforementioned problems associated with the prior art, and there are provided a novel magnetic recording medium and a method of manufacture thereof, characterized in that the substrate of which can be manufactured and processed nearly at room temperatures, and in that it realizes an improved signal to noise ratio and an improved coercive force, thereby suitable for use in the high density recording.

The present invention provides a magnetic recording medium having a magnetic layer formed on a resin substrate, wherein the magnetic layer is comprised mainly of a Co—Pt—Cr composition and contains a silicon oxide, and wherein the silicon oxide contains, in terms of silicon atoms, 8 atomic % or more of silicon and 16 atomic % or less thereof relative to the Co—Pt—Cr composition.

In the magnetic recording medium having the above-mentioned composition, a respective crystal grain of Co—Pt—Cr in its magnetic layer is in a state surrounded by an appropriate amount of silicon oxides so that an inter-crystal interaction between respective crystal grains is efficiently suppressed. Further, a thickness of the magnetic film is set at an appropriate value of 10 nm or more and 25 nm or less. Thereby, the magnetic recording medium is ensured to have a low noise, a high signal to noise ratio and a high coercive force in conjunction.

Further, the method of manufacturing the magnetic recording medium according to the invention is comprised of the step of forming at least a magnetic film on a resin substrate, wherein the magnetic film mainly comprises Co—Pt—Cr and contains a silicon oxide, wherein an amount of silicon element constituting the silicon oxide in terms of atomic percent relative to the Co—Pt—Cr is 8 atomic % or more and 16 atomic % or less, and wherein the magnetic film is formed by the sputtering method in a sputtering chamber under a gas pressure at 0.133 Pa (1 mTorr) or more and 2.66 Pa (20 mTorr) or less.

According to the method of manufacturing the magnetic recording medium of the invention as described above, it is allowed for the temperature of the substrate at the time of forming the magnetic film thereon to be around room temperatures, and is enabled to manufacture the magnetic recording medium that realizes a high signal to noise ratio and a high coercive force by controlling the pressure of Ar gas at an optimum value.

According to an aspect of the present invention, by forming, on its substrate, a magnetic film mainly comprising Co—Pt—Cr and containing a silicon oxide, with the amount of silicon element constituting the silicon oxide in terms of atomic percent relative to the Co—Pt—Cr being 8 atomic % or more and 16 atomic % or less, an inter-crystal interaction between crystal grains of the Co—Pt—Cr in the magnetic layer can be suppressed effectively, thereby providing a novel magnetic recording medium that can realize a high coercive force, a high signal to noise ratio and thus is suitable for use in the high density recording.

According to another aspect of the present, because of use of a resin substrate, a cost of manufacture thereof is largely reduced. Further, a mean surface roughness (coarseness) can be reduced to be 1 nm or less, and a maximum peaking height of protrusions can be suppressed to be 15 nm or smaller, thereby enabling to manufacture a quality magnetic disk featuring an excellent surface smoothness.

According to another aspect of the present, by forming a magnetic film having a thickness of 10 nm or more and 25 nm or less, a high coercive force and a high signal to noise ratio can be realized.

According to another aspect of the present, by composing its magnetic layer such that, assuming a total sum of the Co—Pt—Cr compositions and the silicon element constituting the silicon oxide to be 100 atomic percent, Pt is 12 atomic % or more and 20 atomic % or less; Cr is in excess of 0 atomic % and 10 atomic % or less; Si is 8 atomic % and 16 atomic % or less; and the remaining atomic percent is Co, a depletion of oxygen in the silicon oxide (SiOx) is prevented, thereby enabling effectively to reduce the inter-crystal interaction between the crystal grains of the Co—Pt—Cr, and to realize the high coercive force and the high signal to noise ratio.

Further, according to a further another aspect of the present invention, a method is provided for manufacturing a magnetic recording medium comprising at least a magnetic film formed on a resin substrate, the magnetic film mainly comprising Co—Pt—Cr and containing a silicon oxide, wherein a content of silicon element in the inclusion of the silicon oxide in terms of atomic percent relative to the Co—Pt—Cr is 8 atomic % or more and 16 atomic % or less, and wherein the magnetic film is formed in a chamber under a gas pressure at 0.133 Pa (1 mTorr) or more and 2.66 Pa (20 mTorr) or less by the sputtering method, thereby enabling to realize a high coercive force and a high signal to noise ratio. In particular, according to this method of the invention, because the magnetic film featuring excellent magnetic properties can be formed without the need of heating its substrate, a resin material (plastic material) can be used as its substrate of the magnetic recording medium. Therefore, advantageously according to the invention, the magnetic recording medium having the excellent magnetic properties can be manufactured at a reduced cost.

### BRIEF DESCRIPTION OF THE DRAWINGS

The above and other objects, features and advantages of the present invention will become more apparent from the following description of the presently preferred exemplary embodiment of the invention taken in conjunction with the accompanying drawings, in which:

FIG. 1 is a schematic cross-sectional view of a main part of a magnetic recording medium to which the present invention is applied;

FIG. 2 is a schematic cross-sectional view of an original glass plate for providing a stamper for manufacturing a substrate of the magnetic recording medium;

FIG. 3 is a schematic cross-sectional view of a photo-resist layer formed on the glass base plate for providing the stamper for manufacturing the substrate of the magnetic recording medium;

FIG. 4 is a schematic cross-sectional view of an exposed portion of the photo-resist layer for providing the stamper for manufacturing the substrate of the magnetic recording medium;

FIG. 5 is a schematic cross-sectional view of the photo-resist layer, the exposed portion of which is dissolved, and the glass base plate for providing the stamper for manufacturing the substrate of the magnetic recording medium;

FIG. 6 is a schematic cross-sectional view of a stamper formed on the glass base plate and the photo-resist for providing the stamper for manufacturing the substrate of the magnetic recording medium;

FIG. 7 is a schematic cross-sectional view of the stamper thus provided;

FIG. 8 is a schematic diagram showing a constitution of an inline type sputtering apparatus;

FIG. 9 is a diagram showing a coercive force and a signal to noise ratio of each sample of magnetic disks manufactured according to a first exemplary embodiment of the invention;

FIG. 10 is a diagram showing a coercive force of each sample of magnetic disks manufactured according to a second exemplary embodiment of the invention;

FIG. 11 is a diagram showing a signal to noise ratio of each sample of magnetic disks manufactured according to the second exemplary embodiment of the invention;

FIG. 12 is a diagram showing a coercive force of each sample of magnetic disks manufactured according to a third exemplary embodiment of the invention;

FIG. 13 is a diagram showing a signal to noise ratio of each sample of magnetic disks manufactured according to the third exemplary embodiment of the invention;

FIG. 14 is a diagram showing a coercive force of each sample of magnetic disks manufactured according to a fourth exemplary embodiment of the invention;

FIG. 15 is a diagram showing a signal to noise ratio of each sample of magnetic disks manufactured according to the fourth exemplary embodiment of the invention;

FIG. 16 is a diagram showing coercive forces of respective samples of magnetic disks manufactured according to a fifth exemplary embodiment of the invention; and

FIG. 17 is a diagram showing coercive forces and signal to noise ratios of respective samples of magnetic disks manufactured according to a sixth exemplary embodiment of the invention.

### DESCRIPTION OF THE PREFERRED EMBODIMENT

The magnetic recording medium and the method of manufacture thereof according to a preferred embodiment of the invention will be described in detail with reference to the accompanying drawings in the following.

In the drawing used in the description of the invention, characteristic portions of respective members are enlarged for ease of description, therefore they do not necessarily reflect its actual size ratio. Further, respective materials and compositions of each layer constituting the magnetic recording medium are exemplary ones, and not limited thereto, therefore, they may be selected arbitrarily depending on each object and performance construed within the scope of the invention.

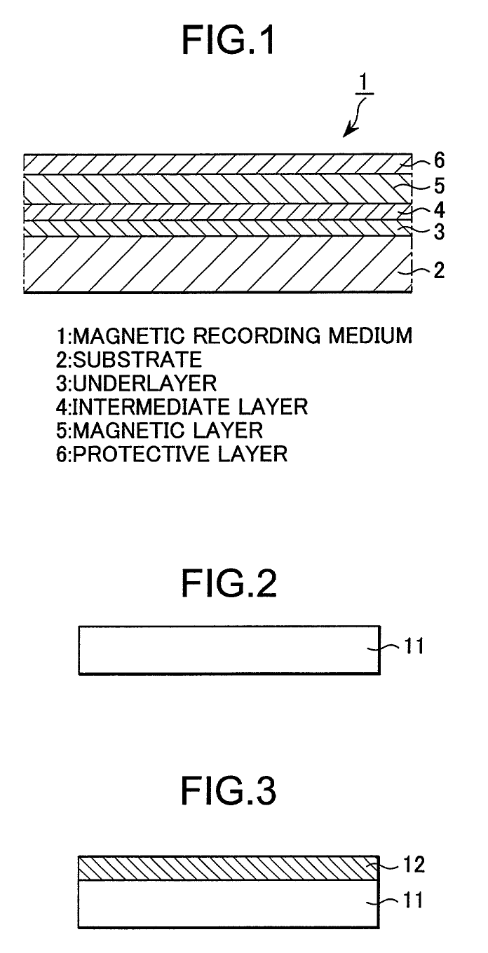

The magnetic recording medium according to the invention is a metallic thin film type magnetic recording medium having a magnetic thin film formed on a substrate, the magnetic thin film mainly comprising a Co—Pt—Cr which is a ferromagnetic substance. With reference to FIG. 1, the magnetic recording medium 1 is comprised of: a substrate 2; an underlayer (backing) 3 formed on the substrate 2; an intermediate layer 4 formed on the underlayer 3; a magnetic layer 5 formed on the intermediate layer 4; and a protective layer 6 formed on the magnetic layer 5.

The magnetic layer 5 is made of mainly Co—Pt—Cr compositions and contains a silicon oxide (SiOx; x is 1 or more and 2 or less). Further, a content of silicon element constituting the silicon oxide in the magnetic layer 5 in terms of atomic percent relative to the contents of the Co—Pt—Cr is specified to be 8 atomic % or more and 16 atomic % or less. Still further, a thickness of the magnetic layer 5 is specified at 10 nm or more and 25 nm or less.

This magnetic layer 5 has such a structure that the silicon oxide (SiOx; x is 1 or more and 2 or less) is scattered likewise an island between crystal grains of the Co—Pt—Cr composing the magnetic layer 5. Namely, the crystal grain of the Co—Pt—Cr is isolated from each other as being surrounded by the silicon oxide, thereby disrupting the inter-crystal interaction between the crystal grains. Thereby, a noise resulting from a variation of magnetization in a magnetization transition region therein can be minimized. At the same time, because each crystal grain is isolated magnetically from each other, a type of its rotation of magnetization becomes simultaneous, thereby substantially increasing the coercive force. Namely, the magnetic recording medium 1 of the invention is ensured to provide a novel magnetic recording medium having a high signal to noise ratio and a high coercive force as well. It should be noted, however, that the scope of the invention is not limited to the microstructure of the exemplary magnetic layer 5 described above.

Now, if the amount of silicon element constituting the silicon oxide contained in the magnetic layer in terms of atomic percent relative to the Co—Pt—Cr is less than 8 atomic %, the effectiveness of the invention for surrounding the crystal grains of the Co—Pt—Cr for isolation thereof is not sufficient, thereby failing to obtain a high signal to noise ratio and a high coercive force so much as desired.

On the other hand, if the content of the silicon element constituting the silicon oxide in the magnetic layer in terms of atomic percent relative to the Co—Pt—Cr becomes larger than 16 atomic %, both its signal to noise ratio and its coercive force decrease contrarily because of a decrease in a relative amount of the Co—Pt—Cr in the magnetic layer.

Therefore, by specifying such that the amount of the silicon element constituting the silicon oxide (SiOx; x is 1 or more and 2 or less) in terms of atomic percent relative to the Co—Pt—Cr is 8 atomic % or more and 16 atomic % or less, a ratio between the crystal grains of the Co—Pt—Cr and the silicon oxide for surrounding these crystal grains becomes optimum. Thereby, the inter-crystal interaction between the crystal grains can be efficiently disrupted, thereby obtaining the high signal to noise ratio and the high coercive force in conjunction.

Further, if the thickness of the magnetic layer 5 is less than 10 nm, an adverse effect due to a distorted crystal orientation in an initially grown layer becomes greater in the magnetic layer, thereby causing its crystalline magnetic anisotropy to deteriorate, and thereby decreasing both the signal to noise ratio and the coercive force thereof. On the other hand, if the thickness of the magnetic layer 5 exceeds 25 nm, because that a demagnetizing field in the vertical direction decreases and a vertical component of magnetization increases, there may arise a problem that the signal to noise ratio and the coercive force in the horizontal direction will decrease. Because of these reasons, it is preferable for the thickness of the magnetic layer 5 to be in a range of 10 nm or more and 25 nm or less, and more preferably, in a range of 15 nm or more and 20 nm or less. Thereby, the signal to noise ratio and the coercive force thereof can be further improved. Thus, the magnetic recording medium 1 of the invention can be used in recording/reproducing information by means of a high performance magnetic head suitable for the high density recording.

In the composition of the magnetic layer 5, assuming that a total atomic percent of Co—Pt—Cr and silicon element constituting the silicon oxide (SiOx; x is 1 or more and 2 or less) is 100 atomic percent, it is preferable that Pt is 12 atomic % or more and 20 atomic % or less, Cr is more than 0 atomic % and 10 atomic % or less, silicon element constituting the silicon oxide is 8 atomic % or more and 16 atomic % or less, and the remaining portion is Co. By specifying the composition of respective elements composing the magnetic layer 5 within the range described above, an excellent coercive force as well as a substantially improved signal to noise ratio can be given to the magnetic recording medium 1, and its medium noise can be suppressed remarkably.

As the silicon oxide to be used for isolating the crystal grains of Co—Pt—Cr, preferably such an oxide expressed by SiOx is used. More specifically as such the SiOx, SiO₂, SiO or the like may be used. By use of these silicon oxides, because that the inter-crystal interaction between the crystal grains of Co—Pt—Cr can be disrupted more efficiently, further improvements in the S/N ratio and the coercive force can be realized advantageously.

Further, it is also preferable to use another oxide such as Cr₂O₃, TiO₂, ZrO₂, Y₂O₃ or the like in conjunction with the silicon oxide (SiOx) for more effectively isolating the crystal grains of Co—Pt—Cr in the magnetic layer 5. When a film of the magnetic layer 5 is formed on the substrate 2 by sputtering, it may occur that each composition of a target and the magnetic layer deviates from its stoichiometric composition, and thus a preferable magnetic layer having a predetermined characteristic cannot be obtained. When the target containing, for example, SiO₂ as the silicon oxide (SiOx) is sputtered, SiO₂ is repelled from the target in a state split into Si and O, to be deposited on the substrate. However, at this time, there may be likely produced mono Si because of depletion of oxygen atoms.

Such mono silicon cannot surround the crystal grains of Co—Pt—Cr as intended, thereby failing sufficiently to disrupt the inter-crystal interaction between these crystal grains. Namely, there exists Si that does not contribute to the disruption of the inter-crystal interaction between the crystal grains of Co—Pt—Cr in the magnetic layer 5, as a result, the effect on the improvements in the S/N ratio and the coercive force by use of SiO₂ in the magnetic layer 5 may not be obtained so much as it is intended.

Therefore, by addition also of Cr₂O₃, TiO₂, ZrO₂, or Y₂O₃ to the silicon oxide (SiOx), as the oxide to be contained in the magnetic layer 5, even if oxygen (O) of SiOx in the magnetic layer 5 is depleted, these added Cr₂O₃, TiO₂, ZrO₂, or Y₂O₃ can supply oxygen. That is, it can help to minimize the probability of production of mono Si that does not contribute to the disruption of the inter-crystal interaction between the crystal grains of Co—Pt—Cr in the magnetic layer 5. As described above, by allowing for the magnetic layer 5 to contain Cr₂O₃, TiO₂, ZrO₂ or Y₂O₃ in conjunction with SiOx, a significant improvement both in the signal to noise ratio and the coercive force can be achieved.

Compositions of such members other than the above-mentioned magnetic layer 5 including the substrate 2, the underlayer 3, the intermediate layer 4 and the protective layer 6 that constitute the magnetic recording medium 1 as shown in FIG. 1 will be described in the following.

Preferably, the substrate 2 is made of a resin material. By use of the resin material (plastic material), molding of resin substrates with a stamper in an injection molding apparatus or the like is enabled, thereby eliminating the troublesome polishing and cleaning steps required for the conventional metal or glass substrates, and also ensuring an excellent surface flatness to be obtained easily. The resin materials used for the substrate 2 include polymethyl methacrylate, polycarbonate, and polycycloolefin hydrocarbon.

Further, preferably, a mean surface roughness of the substrate 2 is 1 nm or less, and a maximum peaking height of any protrusion is 15 nm or less. By provision of a smooth surface to the substrate 2 as described above, even if a gap between the magnetic recording medium 1 and the magnetic head is narrowed to be extremely small, a risk of contact or collision between the magnetic recording medium 1 and the magnetic head can be minimized thereby ensuring a stable read/write operation to be performed.

By way of example, the material for use of the substrate 2 is not limited to the resin materials described above, and any materials used for the substrates of conventional recording media may be used as well. More specifically, aluminum, glass and the like may be used.

As for the underlayer (backing) 3, there may be used, for example, Cr, a Cr—W alloy or the like. By forming the underlayer 3 on the substrate 2, the surface flatness of the magnetic layer 5 can be enhanced.

As the intermediate layer 4, there may be used, for example, Co—Cr, Ti, Ti—Cr, Ru, CoRu, Re or CoRe. By forming the intermediate layer 4 under the magnetic layer 5, a crystal orientation in the magnetic layer 5 can be enhanced, thereby improving the magnetic properties thereof substantially.

The reason of the above will be described by way of example of using Ti for the intermediate layer 4. A lattice distance of Ti to be used for the intermediate layer 4 is larger by 15% to 17% than a lattice distance of Co to be used in the magnetic layer 5. On the other hand, because Pt having a large lattice distance is added to Co in the magnetic layer 5, an actual spacing of the magnetic layer 5 becomes larger than a lattice distance of Co alone. Therefore, because that both the lattice distance of Ti composing the intermediate layer 4 and the lattice distance of the magnetic layer 5 are nearly approximated, the crystal orientation in the magnetic layer 5 is substantially improved. Also in a case where Co—Cr, Ti, Ti—Cr, Ru, CoRu, Re or CoRe are used as the intermediate layer 4, substantially the same effect on the improvement of the crystal orientation of the magnetic layer 5 is obtained as with the case in which Ti is used for the intermediate layer 4.

The protective layer 6 is provided for protecting the magnetic recording medium 1 from abrasion, damage or the like when in contact with the magnetic head. Therefore, not only for the protection of the magnetic recording medium 1 but also for protecting the magnetic head from a damage, a thin film having a high hardness, for example, such as carbon (C) is mainly used.

It is also possible to form a lubricating layer containing a lubricant on the protective layer 6. By provision of the lubricating layer formed on the protective layer 6, a coefficient of friction on the surface of the magnetic recording medium 1 can be lowered, thereby improving slide endurance of the magnetic recording medium 1.

The magnetic recording medium 1 having the aforementioned structure is comprised of the magnetic film formed on the substrate, wherein the magnetic film mainly comprises Co—Pt—Cr and contains the silicon oxide and wherein the amount of silicon element constituting the silicon oxide in terms of atomic percent relative to the Co—Pt—Cr is 8 atomic % or more and 16 atomic % or less, and wherein the thickness of the magnetic layer 5 is 10 nm or more and 25 nm or less. Thereby, advantageously, the crystal grains of Co—Pt—Cr in the magnetic layer 5 are surrounded by the silicon oxides (SiOx) thereby substantially reducing the inter-crystal interaction between the crystal grains. Thereby, the magnetic recording medium 1 thus manufactured realizes the high signal to noise ratio and the high coercive force suitable for the high density recording.

Now, a method of manufacturing the magnetic recording medium 1 having the structure and compositions described with reference to FIG. 1 will be described in the following.

First of all, a stamper 13 which serves as an original master plate for producing the substrate 2 made of plastic is manufactured through a mastering process. In this mastering process, as shown in FIG. 2, an original glass plate 11 is prepared and its surface is polished and cleaned with alkali, acid, water jet, ultrasonic and the like.

Then, a photo-resist solution is coated on the surface of the glass plate 11, for example, by a spin-coating method or the like. After coating with the photo-resist solution, it is baked at a temperature 1000° C. or lower to form a photo-resist layer 12 having a predetermined film thickness as shown in FIG. 3.

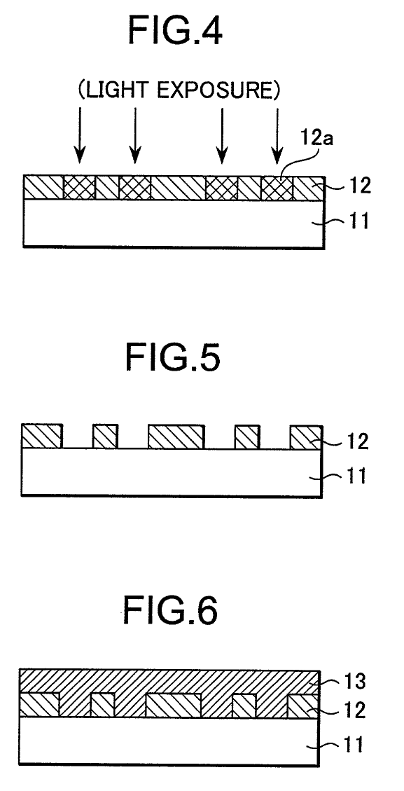

Subsequently, a groove pattern corresponding to its cutting data is exposed onto the photo-resist layer 12 using, for example, a He—Cd laser of 442 nm wavelength, a Kr laser of 412 nm wavelength or the like as shown in FIG. 4. The portion of the photo-resist layer 12 exposed of the pattern is indicated as an exposed portion 12a.

Further, as shown in FIG. 5, a developing process is applied to the photo-resist layer 12 using alkaline developer solution or the like. The exposed portion 12a in the photo-resist layer 12 is dissolved, thereby forming a predetermined convexo-concave pattern corresponding to grooves, servo patterns or the like.

Then, a conductive layer is formed on the photo-resist layer 12 having the predetermined convexo-concave pattern, followed by plating of Ni or the like thereon. As shown in FIG. 6, a stamper 13 is formed on the photo-resist layer 12.

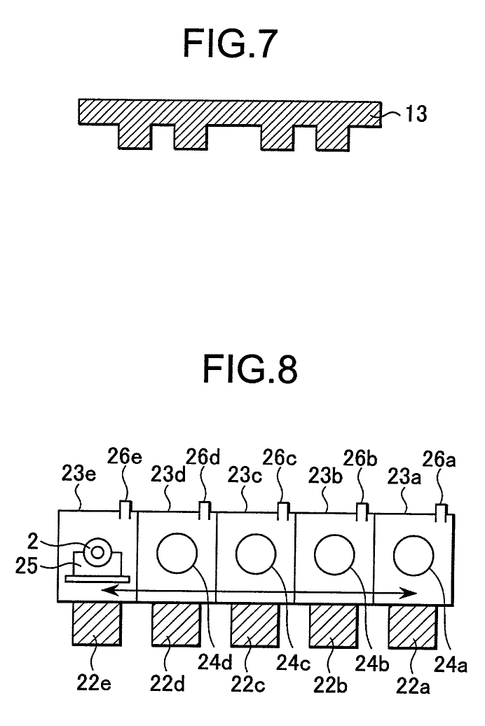

Finally, the stamper 13 thus formed is removed from the original glass plate 11 and the photo-resist layer 12, cleaned in an alkaline solution, an organic solvent or the like so as to remove any photo-resist remaining on the surface to which the convexo-concave pattern has been transferred. Then, the opposite surface having no convexo-concave pattern transferred is ground until it is reduced to have a predetermined thickness. As shown in FIG. 7, the master stamper 13 with the convexo-concave pattern transferred thereon for use in the injection molding is obtained.

By way of example, when manufacturing a planar substrate having no convexo-concave pattern corresponding to the grooves and servo patterns as the substrate 2, the patterning exposure and the developing processes in the aforementioned steps of manufacture are eliminated. In this case, only the coating of the photo-resist solution and the baking thereof are carried out, further followed by the Ni plating or the like. Thereby, the planar stamper without the convexo-concave pattern formed on the surface thereof is obtained.

The substrate 2 is manufactured using the stamper 13 provided as described above, and by injection molding of the resin material. A surface roughness (coarseness) of the substrate 2 thus obtained corresponds to a surface roughness of the photo-resist layer 12. When we actually fabricated the substrate 2 in the manner as described above, a mean roughness of the surface of its substrate 2 is found to be 1 nm or less, and a maximum peaking height of protrusions to be 15 nm or less. Therefore, by manufacturing the substrate 2 according to the invention as described above, a high quality substrate 2 having an excellent surface flatness can be obtained without the need of processing such as removing the protrusions, polishing and cleaning the surface of the substrate 2.

The magnetic recording medium 1 is manufactured by laminating a plurality of lamination films including the magnetic layer 5 on the substrate 2 which is provided as described above. The lamination films including the magnetic layer 5 are formed in an inline type sputtering apparatus 21 as shown in FIG. 8.

The inline type sputtering apparatus 21 has a plurality of chambers 23a, 23b, 23c, 23d and 23e aligned in series. Each chamber 23a to 23e has an exhaust unit 22a to 22e for maintaining inside thereof at a high vacuum, and a gas inlet port 26a to 26e for introducing a sputtering gas into each chamber 23a-23e. At the time of sputtering, respective chambers 23a-23e are degasified by the exhaust units 22a-22e, maintained at a high vacuum, then introduced with a sputter gas such as Ar gas or the like through the gas inlet ports 26a-26e when forming the films.

Inside the chamber 23a, there are provided a cathode 24a to which power is supplied from a target power supply via a matching circuit, a backing plate which is held in contact with the cathode 24a, and a target supported on the backing plate in contact therewith. By way of example, in the manufacture of a magnetic disk 1 according to a preferred embodiment of the invention to be described later, a target for use of the underlayer (backing) 3 made of a Cr—W alloy is used as the target to be mounted inside the chamber 23a.

The chamber 23b, likewise the chamber 23a, is provided with a cathode 24b to which power is supplied from the target power supply via the matching circuit, a backing plate held in contact with the cathode 24b, and a target supported on the backing plate. By way of example, in the manufacture of the magnetic disk according to the embodiment of the invention to be described later, a target for use of the intermediate layer 4 made of a Co—Cr alloy is used as the target to be mounted in the chamber 23b.

The chamber 23c, likewise the chamber 23a, is provided with a cathode 24c to which power is supplied from the target power supply via the matching circuit, a backing plate held in contact with the cathode 24c, and a target supported on the backing plate. By the way, in the manufacture of the magnetic disk according to the embodiment of the invention to be described later, a target for use of the magnetic layer 5 mainly comprising Co—Pt—Cr and containing the silicon oxide (SiOx) is used as the target to be mounted inside the chamber 23c.

The chamber 23d, likewise the chamber 23a, is provided with a cathode 24d to which power is supplied from the target power supply via the matching circuit, a backing plate held in contact with the cathode 24d, and a target supported on the backing plate. By the way, in the manufacture of the magnetic disk according to the embodiment of the invention to be described later, a target for use of the protective layer 6 made of C is used as the target to be mounted inside the chamber 23d.

Further, the inline type sputtering apparatus 21 is provided with a pallet 25 which travels while holding the substrate 2. This pallet 25 holds the substrate 2 so as to face each target inside the chambers 23a-23e and travels between respective chambers 23a-23e.

When forming the lamination films such as the magnetic layer 5 and the like on the substrate 2 in the inline type sputtering apparatus 21 as described above, firstly, the substrate 2 is held by the pallet 25, which is then introduced into the chamber 23e. Then, the exhaust units 22a-22e degasify inside respective chambers 23a-23e and maintain at a high vacuum inside thereof. Subsequently, a sputtering gas such as argon gas or the like is introduced into the chambers 23a-23e through the gas inlet ports 26a-26e, and inside the respective chambers 23a-23e is maintained at a predetermined gas pressure.

Then, the pallet 25 holding the substrate 2 travels to a particular chamber corresponding to a particular thin film to be formed thereon, securing the substrate 2 to face the target, then the target is sputtered with the argon gas. Thereby, this thin film of the target is formed on the substrate 2. Such a process of film deposition as described above is performed sequentially in respective chambers 23a-23e so as to provide the plurality of lamination films including the magnetic layer 5 on the substrate 2.

In the manner as described above, by moving the pallet 25 holding the substrate 2 between respective chambers 23a-23e, the lamination films including the magnetic layer 5 are formed on the substrate 2. Thereby, the magnetic recording medium 1 according to the invention having the lamination films including the magnetic layer 5 formed on the substrate 2 is obtained.

According to the present invention, when manufacturing the magnetic layer 5 on the substrate 2, a gas pressure in the chamber 23c is kept in a range between 0.133 Pa (1 mTorr) or more and 2.66 Pa (20 mTorr) or less. As its gas to be used in sputtering, an inert gas such as argon gas may be used. Thus, it is enabled to manufacture the magnetic recording medium 1 according to the invention that realizes the high signal to noise ratio and the high coercive force, and thereby securing the excellent magnetic properties. In a case where its gas pressure in the chambers is less than 0.133 Pa (1 mTorr), improvements in the signal to noise ratio and the coercive force are insufficient. On the other hand, in a case where its gas pressure in the chambers is greater than 2.66 Pa (20 mTorr), its resulting signal to noise ratio and coercive force decrease than those obtained when the gas pressure in the chambers is 0.133 Pa (1 mTorr).

When forming the magnetic layer 5 by the sputtering method, by setting the gas pressure in the chambers in the range at 0.133 Pa (1 mTorr) or more and 2.66 Pa (20 mTorr) or less, and using the Co—Pt—Cr as its material of the magnetic layer 5, a satisfactory magnetic anisotropy can be secured therein without the need of heating the substrate 2. Therefore, it is enabled to use a resin material (plastic material) that has a lower thermal resistance than metals or the like for the substrate 2.

### EXEMPLARY EMBODIMENTS

We have actually manufactured exemplary magnetic disks of a metal thin film type as the magnetic recording medium embodying the invention using the inline type sputtering apparatus 21 shown in FIG. 8. The result of studies on the magnetic properties of these exemplary magnetic disks will be described in the following.

### EXAMPLE 1

First of all, a relationship between the contents of SiO₂ in the magnetic layer and resulting magnetic properties was examined. Using the stamper manufactured as described above, a resin material was injection-molded so as to obtain a substrate having a convexo-concave pattern on the surface thereof. A mean surface roughness of this substrate was 0.352 nm, and a maximum peaking height was 4.505 nm. By way of example, as a material of this substrate, ZEONEX (trade name), manufactured by Zeon Corporation, was used.

In accordance with the structure as shown in FIG. 1, the underlayer 3 consisting of 84 atomic % Cr-16 atomic t W (hereinafter referred to as 84Cr-16W; the omission of “atomic % ” will also apply to the other compositions in the following), the intermediate layer 4 consisting of 58Co-42Cr, the magnetic layer 5 comprising Co—Pt—Cr and SiO₂, and the protective layer made of C were formed sequentially in lamination on the substrate 2. Then, a fluoric lubricant was coated on the surface of the protective layer 6, thereby obtaining a sample magnetic disk according to the exemplary embodiment of the invention.

At this time, the target mounted in the chamber for forming the magnetic layer 5 in the inline type sputtering apparatus 21 is obtained by mixing Co, Pt, Cr and SiO₂, as its silicon oxide, then baking the mixture thereof. Further, a ratio of mixture of these compositions Co, Pt, Cr and SiO₂ was specified, assuming a total sum of Co, Pt, Cr and silicon element constituting SiO₂ to be 100 atomic %, as follows: Co was 100−(14+6+x) atomic %, Pt was 14 atomic %, Cr was 6 atomic %, and silicon element constituting the SiO₂ was x atomic percent.

A pressure in respective chambers prior to sputtering was set at 2.67×10⁻⁵ Pa (2×10⁻⁷ Torr). Further, respective argon gas pressures therein during sputtering were set at 4 Pa (30 mTorr) for forming the underlayer 3, at 5.3 Pa (47 mTorr) for forming the intermediate layer 4, at 1.1 Pa (8.6 mTorr) for forming the magnetic layer 5, and at 1.6 Pa (12 mTorr) for forming the protective layer 6. Further, a respective rate of forming of its film (or a deposition speed) during the sputtering was set at 2 nm/s for the underlayer 3, at 2 nm/s for the intermediate layer 4, at 2 nm/s for the magnetic layer 5, and at 0.5 nm/s for the protective layer 6. Further, the pallet for holding the substrate 2 was maintained at room temperatures during deposition of these films.

Using a plurality of sample disks having different contents of SiO₂ in the magnetic layer 5 manufactured as above, a respective coercive force Hc thereof was measured using a Remanent Moment Magnetometer (RMM). Further, a respective signal to noise ratio thereof at a linear velocity of 12.9 m/s and at a wavelength of 0.5 μm (approximately 100 kFCI) was measured using an electromagnetic transducer “GUZIK RWA-1632PRML” (Guzik Technical Enterprises, U.S.A.).

As a magnetic head for use in the measurement of signal to noise ratios, a combination type magnetic head combining a recording magnetic head of an inductive type and a reproducing magnetic head of a shielded magneto-resistive type magnetic head was used. As for the recording magnetic head, a recording track width was specified to be 2.7 μm, and a gap length was specified to be 0.35 μm. Further, as for the reproducing magnetic head, a width of a region of the magneto-resistive type element contributing to detection of magnetic fields, i.e., a so-called reproduction MR width, was specified to be 2.3 μm, and a gap of the shield for gripping the magneto-resistive element was specified to be 0.26 μm. These combination type magnetic heads were mounted on a nano-slider.

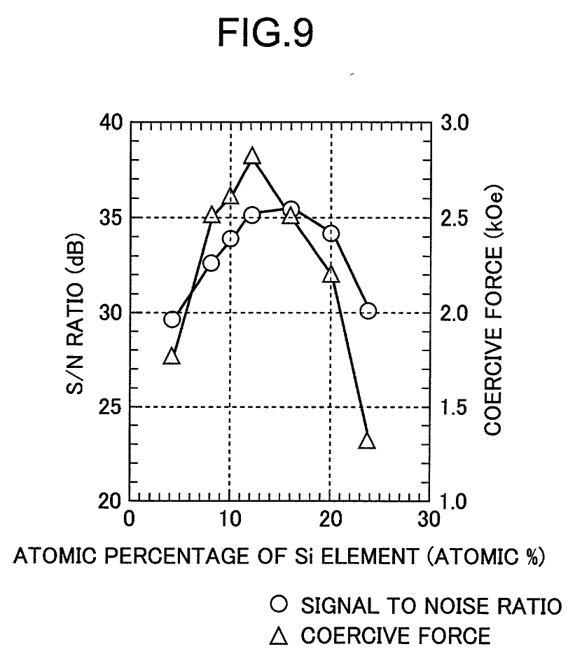

With reference to FIG. 9, a result of measurements of a coercive force and a signal to noise ratio on a respective sample magnetic disk is shown. On the axis of abscissas in FIG. 9, contents of SiO₂ in the magnetic layer are shown in terms of atomic percent of silicon element constituting SiO₂ relative to Co—Pt—Cr. On the right-hand axis of ordinates in FIG. 9, magnitudes of coercive forces of respective sample magnetic disks are shown. The coercive force is indicated in the Oe unit in the drawing, however, it is also indicated in the SI unit (A/m) in the description. A conversion therebetween is based on that 1 Oe nearly equals 79 A/m. On the left-hand axis of ordinates, signal to noise ratios measured on respective sample magnetic disks upon reproducing information are shown.

As clearly shown in FIG. 9, when the contents of SiO₂ in the magnetic layer in terms of atomic percent of silicon element constituting the SiO₂ relative to Co—Pt—Cr were 8 atomic % or more and 16 atomic % or less, advantageously, a high coercive force of 1.82×10⁵ A/m (2.3 kOe) to 1.98×10⁵ A/m (2.5 kOe) and a high signal to noise ratio 35 dB or more were obtained. However, when the contents of SiO₂ in the magnetic layer in terms of atomic percent of silicon element constituting the SiO₂ relative to Co—Pt—Cr therein were less than 8 atomic percent, its medium noise increased substantially thereby rapidly deteriorating both the coercive forces and the signal to noise ratios.

On the other hand, in a case where the contents of SiO₂ in the magnetic layer in terms of the atomic percent of silicon element constituting the SiO₂ relative to the Co—Pt—Cr were in excess of 16 atomic %, in particular, the decrease of the coercive force was remarkable partially therein thereby preventing for the conventional magnetic head to record information thereto. As the result of the above, it was found that by specifying the amount of SiO₂ in the magnetic layer to be 8 atomic % or more and 16 atomic % or less in terms of atomic percent of silicon element constituting the SiO₂ relative to the Co—Pt—C, excellent magnetic properties having realized both the high signal to noise ratio and the high coercive force as well as capable of efficiently disrupting the inter-crystal interaction between the crystal grains of Co—Pt—Cr were obtained.

### EXAMPLE 2

Now, with reference to the optimal compositions of the magnetic layer clarified in the example 1 described above, sample magnetic disks were manufactured likewise those used in the example 1, and used in investigation of an optimal thickness of the magnetic layer 5. On a resin-made substrate 2 provided by mold-injection of the resin material as described above, an underlayer 3 consisting of 84Cr-16W alloy, an intermediate layer 4 consisting of 58Co-42Cr, a magnetic layer 5 comprising Co—Pt—Cr and including SiO₂, and a, protective layer 6 made of C were formed sequentially. Then, a fluoric lubricant was coated on the surface of the protective layer thereby obtaining a plurality of sample magnetic disks.

At this time, a target to be mounted in the chamber for forming a film of the magnetic layer in the inline type sputtering apparatus was obtained by mixing Co, Pt, Cr and a silicon oxide of SiO₂, and baking the mixture thereof. These compositions of Co, Pt, Cr and SiO₂ were mixed in the following ratios in terms of atomic percent, assuming a total sum thereof to be 100 atomic %, such that Co was 68 atomic %, Pt was 14 atomic %, Cr was 6 atomic %, and silicon element constituting the SiO₂ was 12 atomic %. Apart from varying the thickness of the magnetic layer 5 under the conditions described above, in the same way as in the case of the example 1, a plurality of sample magnetic disks were manufactured for this purpose.

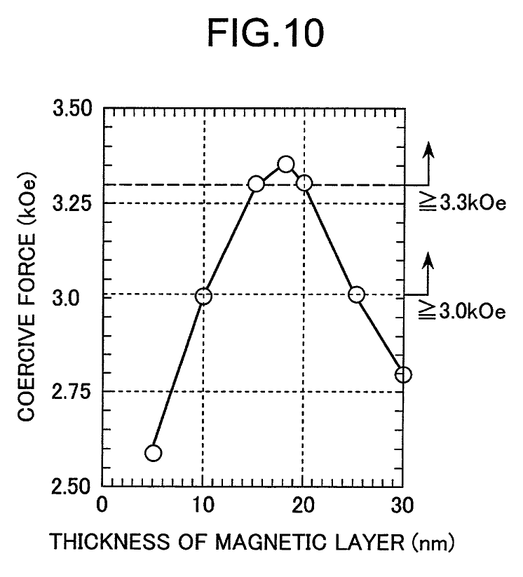

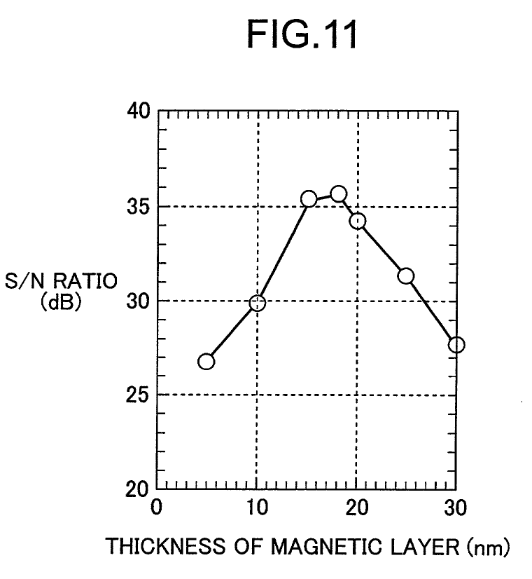

Then, by the same method as for the samples of the example 1, the plurality of sample magnetic disks having a different thickness of the magnetic layer were measured of their coercive forces and signal to noise ratios A result of measurements of coercive forces of respective sample magnetic disks is shown in FIG. 10. The axis of abscissas in FIG. 10 indicates the thickness of the magnetic layer while the axis of ordinates indicates the magnitude of coercive forces of the sample magnetic disks. Although the magnitude of coercive forces is indicated by the Oe unit in the drawings, it is also indicated by the SI unit in the description. The conversion therebetween is based on that 1 Oe nearly equals 79 A/m. Further, a result of measurements of signal to noise ratios of respective sample magnetic disks is shown in FIG. 11. The axis of abscissa in FIG. 11 indicates the thickness of the magnetic layer while the axis of ordinates indicates the signal to noise ratio of respective sample magnetic disk when reproducing information.

As clearly known from FIG. 10, when the thickness of the magnetic layer was in a range of 10 nm or more and 25 nm or less, a high coercive force of 2.37×10⁵ A/m (3.0 kOe) or more was obtained. In particular, when the thickness of the magnetic layer was in a range of 15 nm or more and 20 nm or less, it was found that an extremely high coercive force of 2.61×10⁵ A/m (3.3 kOe) or more can be obtained. On the other hand, when the thickness of the magnetic layer was less than 10 nm, its coercive force indicated a small value of 2.37×10⁵ A/m (3.0 kOe) or less. Also when the thickness of the magnetic layer was in excess of 25 nm, its coercive force indicated a small value of 2.37×10⁵ A/m (3.0 kOe) or less. Therefore, as the result of the above examination, it was clarified that the high coercive force can be obtained by setting the thickness of the magnetic layer in the range between 10 nm or more and 25 nm or less.

Further, as is clearly known from FIG. 11, when the thickness of the magnetic layer was in the range of 10 nm or more and 25 nm or less, a high signal to noise ratio greater than 30 dB was obtained. In particular, when the thickness of the magnetic layer was in the range of 15 nm or more and 20 nm or less, an extremely high signal to noise ratio of approximately 35 dB was found obtainable. On the other hand, when the thickness of the magnetic layer was less than 10 nm, its signal to noise ratio indicated a low value below 30 dB. Also when the thickness of the magnetic layer was in excess of 25 nm, its signal to noise ratio indicated a low value below 30 dB. As the result of the above, it was found that the high signal to noise ratio can be obtained by controlling the thickness of the magnetic layer in the range of 10 nm or more and 25 nm or less.

It was thus clarified from the result of measurements on the example 2 of the invention that by specifying the thickness of the magnetic layer in the range of 10 nm or more and 25 nm or less, the excellent magnetic properties having the high coercive force and also the high signal to noise ratio secured together can be obtained. Still further, it was found that by specifying the thickness of its magnetic layer in the range of 15 nm or more and 20 nm or less, the magnetic layer having the excellent magnetic properties can be provided.

### EXAMPLE 3

In the next, two different kinds of magnetic disks having a structure in accordance with FIG. 1 were fabricated by the same method as of the example 1 in order to investigate an optimal gas pressure for forming the thin film of the magnetic layer. The magnetic disk was constructed by forming lamination films of an underlayer 3 consisting of 84Cr-16W alloy, an intermediate layer 4 consisting of 58Co-42Cr, a magnetic layer 5 comprising Co—Pt—Cr and SiO₂, and a protective layer 6 made of C, sequentially on a substrate which was made of a resin material and injection-molded as described above. Then, a fluoric lubricant was coated on the surface of the protective layer thereby providing the sample magnetic disks of the example 3.

At this time, one of two kinds of targets to be installed in the chamber of the inline type sputtering apparatus 21 for forming one of the two different kinds of the magnetic layers 5 was obtained by mixing Co, Pt, Cr and SiO₂, as its silicon oxide (SiOx), then by baking the mixture thereof. By the way, the ratio of the mixture of these compositions was specified, assuming a total sum of these compositions of the mixture in terms of atomic percent to be 100%, as follows: Co was 68 atomic %, Pt was 14 atomic %, Cr was 6 atomic %, silicon element constituting the silicon oxide was 12 atomic %. Under the above conditions, and except that the pressure of argon gas in the chamber was varied when forming the magnetic layer, a plurality of sample magnetic disks were manufactured approximately in the same manner as in the case of the example 1.

The other one of the two kinds of targets to be installed in the chamber of the inline type sputtering apparatus 21 for forming the other one of the two types of the magnetic layers 5 was obtained by mixing Co, Pt, Cr and SiO₂, as its silicon oxide, and baking the mixture thereof. The ratio of the mixture of these compositions, assuming a total sum of these compositions of Co, Pt, Cr and silicon element constituting the silicon oxide in terms of atomic percent to be 100%, was specified as follows: Co was 64 atomic %, Pt was 14 atomic %, Cr was 6 atomic %, and silicon element constituting the silicon oxide was 16 atomic %. Under the above conditions, and except that the pressure of argon gas in the chamber is varied when forming the magnetic layer 5, the plurality of sample magnetic disks were manufactured approximately in the same manner as in the case of the example 1.

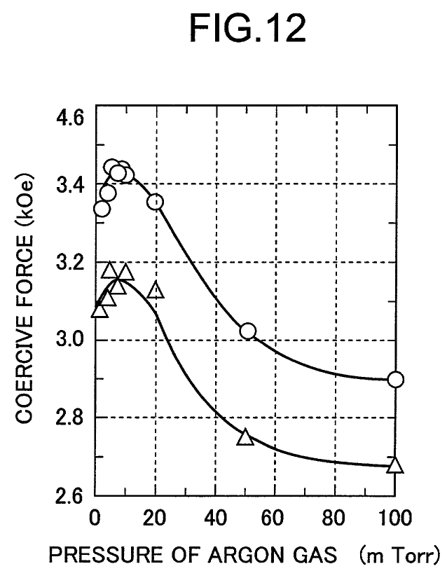

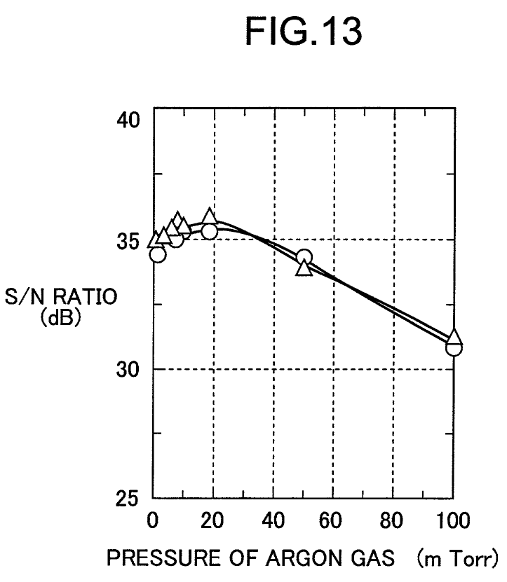

With the plurality of these sample magnetic disks manufactured as described above, their coercive forces and signal to noise ratios were measured in the same way as in the example 1. A result of measurements on their coercive forces of respective sample magnetic disks is shown in FIG. 12. The axis of abscissas in FIG. 12 indicates pressures of argon gas for forming the magnetic layer 5. By the way, although the pressure of argon gas is indicated in the unit of mTorr in the drawing, it is also indicated in the SI unit (Pa) in the description. The conversion of values therebetween is based on that 1 mTorr nearly equals 0.133 Pa. The axis of ordinates represents magnitudes of coercive forces of respective sample magnetic disks. By the way, although the coercive force is indicated in the Oe unit in the drawing, it is also indicated in the SI unit (A/m) in the text. The conversion of values therebetween is based on that 1 Oe nearly equals 79 A/m. A result of measurements of respective sample magnetic disks on their signal to noise ratios is shown in FIG. 13. The axis of abscissas in FIG. 13 indicates pressures of argon gas when forming the magnetic layer 5. The unit of indication is the same as referred to in FIG. 12. The axis of ordinates represents a signal to noise ratio of a respective sample magnetic disk when information is reproduced.

In FIGS. 12 and 13, a circle ∘ indicates a result of evaluation on a sample magnetic disk in which the content of SiO₂, or an amount of silicon element constituting the SiO₂ in terms of atomic percent relative to Co—Pt—Cr is 12 atomic percent. Further, a triangle Δ in FIGS. 12 and 13 indicates a result of evaluation on a sample magnetic disk in which the content of SiO₂, or an amount of silicon element constituting the SiO₂ in terms of atomic percent relative to Co—Pt—Cr is 16 atomic percent.

As clearly known from FIG. 12, when the pressure of argon gas was in a range at 0.133 Pa (1 mTorr) or more and 2.66 Pa (20 mTorr) or less at the time of forming the magnetic layer 5, irrespective of the contents of SiO₂, a high coercive force of 2.45×10⁵ A/m (3.10 kOe) or more was obtained. However, when the pressure of argon gas was decreased to less than 0.133 Pa (1 mTorr), for example, a coercive force of a sample magnetic disk having an inclusion of SiO₂ in the magnetic layer 5, in which an amount of silicon element constituting the SiO₂ in terms of atomic percent relative to Co—Pt—Cr compositions was 16 atomic percent, was 2.44×10⁵ A/m (3.09 kOe). This value is insufficient in consideration of the recording capability of the conventional magnetic head presently in use. On the other hand, when the pressure of argon gas exceeded 2.66 Pa (20 mTorr), its signal to noise ratio and also coercive force thereof decreased lower than those obtained when the pressure of argon gas was 0.133 Pa (1 mTorr). As the result of these discussions, it was clarified that by controlling the pressure of the sputter gas at the time of forming the magnetic layer 5 to be in the range at 0.133 Pa (1 mTorr) or more and 2.66 Pa (20 mTorr) or less, a high coercive force was ensured to be obtained.

Further, as clearly known from FIG. 13, when the pressure of argon gas was in the range at 0.133 Pa (1 mTorr) or more and 2.66 Pa (20 mTorr) or less, irrespective of the contents of SiO₂, an extremely high signal to noise ratio of 35 dB or more was obtained. However, when the pressure of argon gas was less than 0.133 Pa (1 mTorr), a signal to noise ratio of a sample magnetic disk containing SiO₂ in the magnetic layer 5, in which an amount of silicon element constituting the SiO₂ in terms of atomic percent relative to Co—Pt—Cr was, for example, 12 atomic %, was 34.2 dB. This value is inadequate in consideration of the recording capability of the conventional magnetic head now in use. On the other hand, when the pressure of argon gas was in excess of 2.66 Pa (20 mTorr), both its signal to noise ratio and coercive force decreased lower than those obtained when the pressure of argon gas was 0.133 Pa (1 mTorr). As the result of these observations, it was clarified that by controlling the pressure of the sputtering gas in the range at 0.133 Pa (1 mTorr) or more and 2.66 Pa (20 mTorr) or less at the time of forming the magnetic layer 5, a high signal to noise ratio was ensured to be obtained.

As the result of measurements of the example 3 described above, it was clarified that by specifying the pressure of the sputter gas in the range at 0.133 Pa (1 mTorr) or more and 2.66 Pa (20 mTorr) or less at the time of forming the magnetic layer 5, an excellent magnetic disk featuring the high coercive force in conjunction with the high signal to noise ratio, that is, a magnetic disk suitable for the high density recording can be manufactured.

### EXAMPLE 4

As a ferromagnetic substance of the magnetic layer 5 according to example 4 of the invention, Co-Pt and a silicon oxide (SiO₂) were used in one case, and Co—Pt—Cr, a silicon oxide (SiO₂) and a chromic oxide (Cr₂O₃) were used in another case thereof. Then, their sample magnetic disks were manufactured in accordance with the structure of FIG. 1, approximately in the same manner as in the example 1, and their effectiveness as the magnetic layer was investigated, respectively. On each substrate made of the resin material and injection-molded as described above, an underlayer 3 consisting of 84Cr-16W alloy; an intermediate layer 4 consisting of 58Co-42Cr; a magnetic layer 5 consisting of either Co—Pt and SiO₂ or Co—Pt—Cr, SiO₂ and Cr₂O₃; and a protective layer 6 made of C were formed sequentially in lamination. Then, a fluoric lubricant was coated on the surface of the protective layer 6 thereby obtaining two kinds of sample magnetic disks having the different magnetic layers.

At this time, a target to be installed in the chamber of the inline type sputtering apparatus 21 for forming the magnetic layer 5 as one of the two different kinds thereof was obtained by mixing Co, Pt and a silicon oxide of SiO₂, and baking the mixture thereof. Assuming a total sum in atomic percent of the compositions of Co, Pt and silicon element constituting SiO₂ to be 100 atomic percent, respective ratios of the mixture thereof were specified as follows: Co was 64 atomic %, Pt was 20 atomic %, and silicon element constituting the SiO₂ was 16 atomic %. Under the above conditions, and except that the thickness of the magnetic layer 5 was varied, a plurality of the sample magnetic disks of example 4 were obtained in the same manner as in the example 1.

At this time, a target to be installed in the chamber of the inline type sputtering apparatus 21 for forming the other one of the two kinds of the magnetic layers 5 was obtained by mixing Co, Pt, Cr, a silicon oxide of SiO₂ and a chromic oxide of Cr₂O₃, and baking the mixture thereof. Assuming a total sum in atomic percent of the compositions of Co, Pt, Cr, silicon element constituting SiO₂, and Cr element constituting Cr₂O₃ to be 100 atomic percent, respective ratios of the mixture thereof were specified as follows: Co was 67 atomic %, Pt was 14 atomic %, Cr was 6 atomic %, silicon element constituting the SiO₂ was 12 atomic %, and Cr element constituting the Cr₂O₃ was 1 atomic %. Under the above conditions, and except that the thickness of the magnetic layer 5 was varied, a plurality of the sample magnetic disks of example 4 were obtained in the same way as those in the example 1.

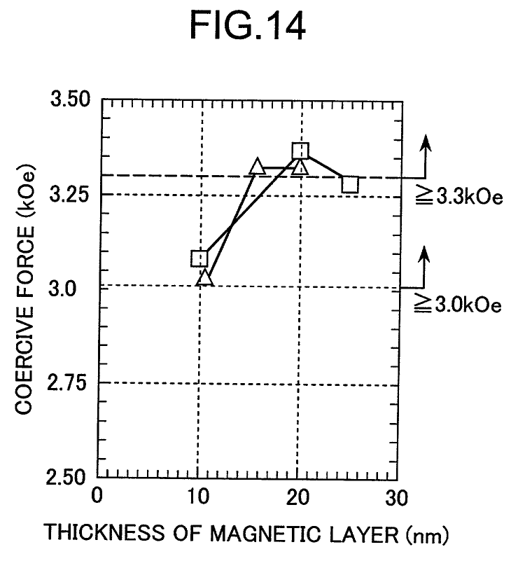

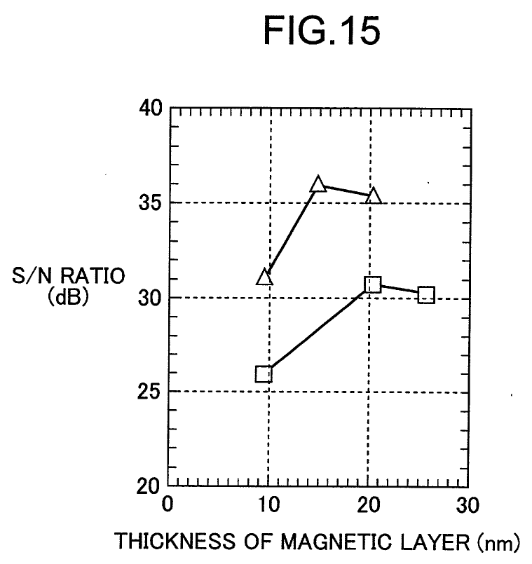

Using the plurality of sample magnetic disks manufactured as described above, their coercive forces and signal to noise ratios were measured by the same method as that of the exemplary example 1. A result of measurements of their coercive forces of respective sample magnetic disks is shown in FIG. 14. The axis of abscissas in FIG. 14 represents thicknesses of respective magnetic layers 5 while the axis of ordinates thereof represents a magnitude of its coercive force of the sample magnetic disk. By the way, although the coercive force is indicated in Oe unit in the drawing, it is also indicated in the SI unit (A/m) in conjunction therewith in the description. The conversion of values therebetween is based on that 1 Oe nearly equals 79 A/m. Further, a result of measurements of their signal to noise ratios of respective sample magnetic disks is shown in FIG. 15. The axis of abscissas in FIG. 15 represents thicknesses of their magnetic layers 5 while the axis of ordinates represents their signal to noise ratios of respective sample magnetic disk when information is reproduced therefrom.

A square □ in FIGS. 14 and 15 indicates a result of evaluations on a sample magnetic disk in which the content of SiO₂ as a ratio of silicon element constituting the SiO₂ with respect to the remaining atomic percent of Co—Pt was 16 atomic %. Further, a triangle Δ in FIGS. 14 and 15 indicates a result of evaluations on a sample magnetic disk in which the content of SiO₂ as a ratio of silicon element constituting the SiO₂ with respect to the atomic percents of Co—Pt—Cr was 12 atomic %, and the content of Cr₂O₃ as a ratio of Cr element constituting the Cr₂O₃ with respect to the atomic percents of Co—Pt—Cr was 1 atomic %.

As clearly known from FIG. 14, the sample magnetic disk containing Co—Pt as its ferromagnetic substance in its magnetic layer 5, and provided that a thickness of the magnetic layer 5 was in a range of 10 nm or more and 25 nm or less, was found to show a high coercive force 2.37×10⁵ A/m (3.0 kOe) or more. Also, the sample magnetic disk containing Co—Pt—Cr, SiO₂ and Cr₂O₃ in conjunction was found to show a high coercive force 2.37×10⁵ A/m (3.0 kOe) or more, in the range of the thickness of its magnetic layer at 10 nm or more and 25 nm or less.

On the other hand, as clearly known from FIG. 15, the sample magnetic disks containing Co—Pt—Cr, SiO₂ and also Cr₂O₃ were found to show a higher signal to noise ratio than that of the sample magnetic disks containing Co—Pt as its ferromagnetic substance and SiO₂ in the magnetic layer 5. Further, as clearly known from a comparison with the signal to noise ratios of the sample magnetic disks shown in FIG. 11 in which the contents of SiO₂ in the magnetic layer 5 in terms of atomic percent of silicon element constituting the SiO₂ relative to Co—Pt—Cr is 12%, the sample magnetic disk containing Co—Pt—Cr, SiO₂ and also Cr₂O₃ was found to show an improved signal to noise ratio. This is considered due to that because Cr₂O₃ was used together with the silicon oxide SiO₂, oxygen was secured to be supplied to a mono Si to help to form SiO₂, thereby effectively reducing the inter-crystal interaction between crystal grains of Co—Pt—Cr.

As the result of the measurements using the exemplary example 4 described above, it was clarified that by addition of Cr₂O₃ in conjunction with SiO₂ in the magnetic layer 5, the magnetic properties thereof can be further improved.

### EXAMPLE 5

Sample magnetic disks were manufactured in accordance with the structure of FIG. 1 and by the same method as in the example 1 so as to investigate an optimum amount of Cr to be contained in the magnetic layer containing oxides. On the substrate made of the resin material prepared by injection molding, there were formed sequentially lamination films of an underlayer 3 consisting of 84Cr-16W alloy; an intermediate layer 4 consisting of 58Co-42Cr; a magnetic layer 5 comprising Co—Pt—Cr and SiO₂; and a protective layer 6 made of C. Then, a fluoric lubricant was coated on the surface of the protective layer 6 thereby obtaining a plurality of sample magnetic disks of example 5.

At this time, a target to be installed in the chamber of the inline type sputtering apparatus 21 for forming this magnetic layer 5 was obtained by mixing Co, Pt, Cr and SiO₂, as the silicon oxide, and baking the mixture thereof. Assuming a total sum in atomic percent of Co, Pt, Cr elements and silicon element constituting the SiO₂ to be 100 atomic %, they were mixed in the ratios specified as follows: Co was 100−(16+x+12) atomic %, Pt was 16 atomic %, Cr was x atomic %, and silicon element constituting the silicon oxide was 12 atomic %. Further, the contents of Cr were varied to be 4 atomic %, 6 atomic %, 10 atomic % and 12 atomic %. Under the above conditions, and except that the value of a product Mr·t between a residual magnetization Mr and a thickness t of the magnetic layer was varied, a plurality of sample magnetic disks of the example 5 were manufactured by the same method as that of the example 1.

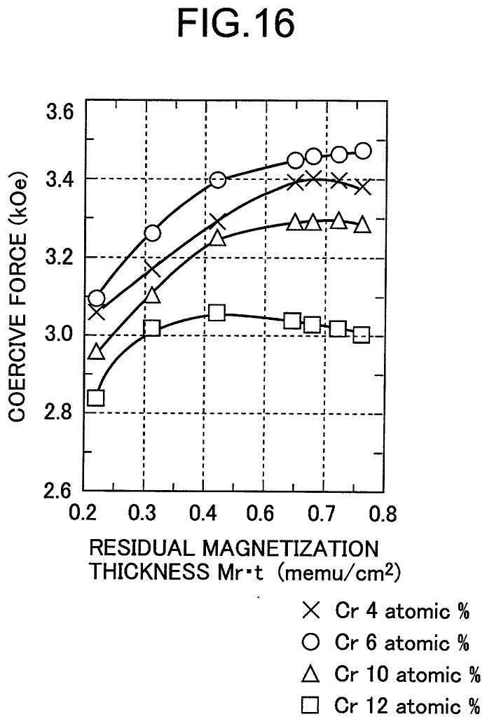

Using the plurality of sample magnetic disks manufactured as described above, the coercive forces thereof were measured by the same method as described with reference to the example 1. A result of measurements on their coercive forces of respective sample magnetic disks is shown in FIG. 16. The axis of abscissas in FIG. 16 represents the product Mr·t between the residual magnetization Mr and the thickness t of the magnetic layer, while the axis of ordinates thereof represents magnitudes of the coercive forces of respective sample magnetic disks. By the way, although the coercive force is indicated in the Oe unit in the drawing, it is also indicated in the SI unit (A/m) in the text. The conversion of values therebetween is based on that 1 Oe nearly equals 79 A/m.

As clearly shown in FIG. 16, when the content of Cr was 10 atomic % or less, assuming a total sum of Co—Pt—Cr and the silicon element constituting the SiO₂ to be 100 atomic %, it was found that a high coercive force can be obtained in a wide range of the product Mr·t. In particular, assuming the total sum of Co—Pt—Cr and silicon element constituting the SiO₂ to be 100 atomic %, when the contents of Cr was 4 atomic %, 6 atomic % or 10 atomic %, an excellent coercive force greater than 2.53×10⁵ A/m (3.2 kOe) was obtained.

Therefore, it was clarified that, assuming the total sum of compositions of Co—Pt—Cr and silicon element constituting the SiO₂ to be 100 atomic %, it is preferable for the contents of Cr to be in excess of 0 atomic % and 10 atomic % or less, and in particular, to be 4 atomic % or more and 10 atomic % or less.

### EXAMPLE 6

An optimum amount of Pt in the magnetic layer 5 containing oxides was studied using sample magnetic disks of example 6 manufactured corresponding to the structure of FIG. 1 and by the same method as in the example 1. On the substrate made of the resin and injection-molded as described above, there were sequentially formed lamination films of an underlayer 3 consisting of a 84Cr-16W alloy; an intermediate layer 4 consisting of 58Co-42Cr; a magnetic layer 5 comprising a Co—Pt—Cr alloy and including SiO₂; and a protective layer 6 made of C. Then, a fluoric lubricant was coated on the surface of the protective layer 6 thereby obtaining a plurality of sample magnetic disks of example 6.

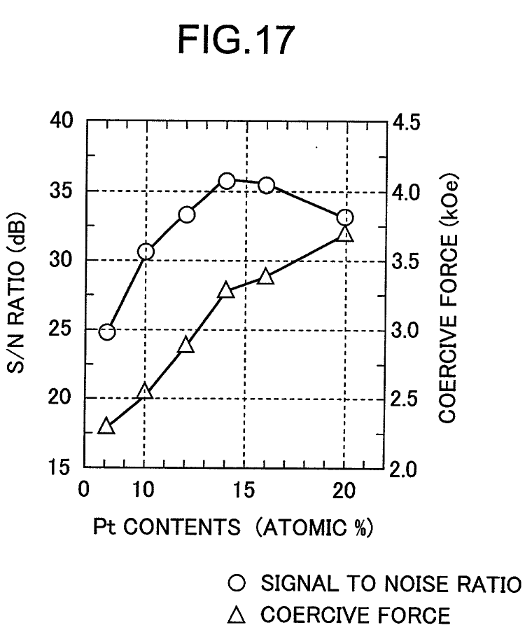

At this time, a target to be installed in the chamber of the inline type sputtering apparatus for forming the magnetic layer 5 was obtained by mixing Co, Pt, Cr and SiO₂ as its silicon oxide, and baking the mixture thereof. Here, assuming a total sum in atomic percent of Co, Pt, Cr and silicon element constituting SiO₂ to be 100 atomic %, ratios of the mixture of Co, Pt, Cr and silicon element constituting the SiO₂ was preferably as follows: Co was 100−(x+6+12) atomic %, Pt was x atomic %, Cr was 6 atomic % and silicon element constituting the SiO₂ was 12 atomic %. Further, except that the contents of Pt are varied as shown in FIG. 17, a plurality of sample magnetic disks were manufactured by the same method as in the example 1.

Using these plurality of sample magnetic disks manufactured as above, their coercive forces and signal to noise ratios were measured by the same method as in the example 1. A result of measurements on the coercive force and the signal to noise ratio of respective sample magnetic disks is shown in FIG. 17. The contents of Pt indicated on the axis of abscissas in FIG. 17 represent its value in atomic percent assuming a total sum of Co—Pt—Cr and silicon element constituting SiO₂ to be 100 atomic %. The axis of ordinates on the right-hand indicates the magnitude of coercive forces of respective sample magnetic disks. By the way, although the coercive force is indicated in the Oe unit in the drawing, it is also indicated in the SI unit (A/m) in the description. The conversion of values therebetween is based on that 1 Oe nearly equals 79 A/m. Further, the axis of ordinates on the left-hand side represents the signal to noise ratios of respective sample magnetic disks when information is reproduced therefrom.

As clearly known from FIG. 17, when the content of Pt was specified to be greater than 12 atomic percent, assuming the total sum of the contents of Co—Pt—Cr and silicon element constituting the SiO₂ to be 100 atomic %, an excellent coercive force in excess of 2.37×10⁵ A/m (3.0 kOe) was found to be obtainable.

Further, when the content of Pt was specified to be in the range of 12 atomic % or more and 20 atomic % or less when the total sum of the contents of Co—Pt—Cr and silicon element constituting SiO₂ was 100 atomic %, a high signal to noise ratio in excess of 33 dB was obtained. In particular, when the content of Pt was 13 or more atomic % and 16 atomic % or less assuming the total sum of the contents of Co—Pt—Cr and silicon element constituting the SiO₂ to be 100 atomic %, it was found that its signal to noise ratio exceeded 35 dB and its medium noise could be suppressed remarkably.

As the result of the above measurements, it was clarified that the content of Pt was preferably in the range of 12 or more atomic % and 20 atomic % or less, and more particularly, in the range of 13 atomic % and 16 atomic % or less, assuming the total sum of the contents of Co—Pt—Cr and silicon element constituting the SiO₂ to be 100 atomic %.

### EXAMPLE 7

Under the conditions described in the following TABLE 1, lamination films of an example 7 according to the present invention were formed, and measurements of their magnetic properties, electromagnetic conversion characteristics and environmental tests were conducted.

TABLE 1

| | | | | | 62 Co- | |
|---|---|---|---|---|---|---|
| | | | | | 17.5 Pt- | |
| | RF | 84 Cr- | | | 8.5 Cr- | |
| | Glow | 16 W | 50 Ti-50 W | Ru | 12 SiO₂ | C |
| Pressure | 13.3 | 2.7 | 0.8 | 10.0 | 1.1 | 1.1 |
| (Pa) | | | | | | |
| Input | 200.0 | 50.0 | 150.0 | 180.0 | 180.0 | 1200.0 |
| Power (W) | | | | | | |
| Time | 8.0 | 6.7 | 11.1 | 20.2 | 11.1 | 5.3 |
| (sec) | | | | | | |
| Film | | 1.0 | 10.0 | 20.0 | 11.0 | 6.0 |
| Thickness | | | | | | |
| (nm) | | | | | | |

On a plastic substrate which was made of polycycloolefin (ZEONEX; trade name of Zeon Corporation) and subjected to a RF glow processing, there were formed subsequently films of 84Cr-16W/50Ti-50W/Ru/62Co-17.5Pt-8.5Cr-12SiO₂/C in this order. A result of measurements of magnetic properties thereof obtained using a Vibrating Sample Magnetometer (VSM) was such that Mr·t=0.4 mA, Hc=255 kA/m, S*=0.85 (where S*: aspect ratio of coercive force). Magnetic conversion characteristics were measured using a spin stand LS-90 (Kyodo Denshi System Co., Ltd., Japan), Guzik RWA-1632PRML (Guzik Technical Enterprises, U.S.A.). A GMR nano-slider head having a track width of 0.5 μm at recording and a track width of 0.25 μm at reproducing, and floating at 25 nm was used. Signal to noise ratios were measured in an area with a radius of 28.7 mm, at 5400 rpm and at a 250 kFCI recording density. As a result, an absolute value of 27 dB of S/N was obtained. As a result of measurements of this medium with a scanning electron microscope (SEM), it was confirmed that no crack was initiated. Further, this recording/reproducing medium was left in a clean environment of class 100 or less, at 80° C., and 80% of humidity for 4 hours, then its temperature was decreased down to −40° C. taking one hour, left at this temperature for one hour, and then returned to the room temperature taking 4 hours. Subsequently, it was observed if there occurred any film lifting (exfoliation) using an optical microscope, there was observed none. In order to confirm that this disk is not deformed, a floating operation using the aforementioned head mounted on the spin stand LS90 described above was carried out, and it was verified that a good electromagnetic conversion property has been ensured to be obtainable without causing a crash between the head and the disk.

What is claimed is:

1. A magnetic recording medium having a magnetic film formed on a substrate, said magnetic film mainly comprising Co—Pt—Cr and including a silicon oxide, wherein a content of silicon element constituting said silicon oxide in terms of atomic percent relative to said Co—Pt—Cr is 8 or more atomic % and 16 atomic % or less.

2. The magnetic recording medium according to claim 1, wherein said substrate is made of a resin.

3. The magnetic recording medium according to claim 1, wherein a thickness of said magnetic layer is 10 nm or more and 25 nm or less.

4. The magnetic recording medium according to claim 1, wherein, assuming a total sum of said Co—Pt—Cr and said silicon element constituting said silicon oxide to be 100 atomic %, Pt is 12 atomic % or more and 20 atomic % or less, Cr is in excess of 0 atomic % and 10 atomic % or less, Si is 8 atomic % or more and 16 atomic % or less, and Co is the remaining atomic percent.

5. The magnetic recording medium according to claim 1, wherein said substrate is provided with a convexo-concave pattern formed on a surface thereof.

6. The magnetic recording medium according to claim 1, wherein a mean surface roughness of said substrate is 1 nm or less, and a maximum peaking height thereof is 15 nm or less.

7. A method of manufacturing a magnetic recording medium comprising at least a step of forming a magnetic film mainly comprising Co—Pt—Cr and including a silicon oxide on a substrate made of a resin, an amount of silicon element constituting said silicon oxide in terms of atomic percent relative to said Co—Pt—Cr being 8 atomic % or more and 16 atomic % or less, wherein:
said magnetic film is formed by sputtering in a sputtering chamber at a gas pressure of 0.133 Pa or more and 2.66 Pa or less.

8. The method of manufacturing the magnetic recording medium according to claim 7, wherein said substrate is kept in a non-heated state while said magnetic recording film is formed by sputtering in said chamber.

9. The method of manufacturing the magnetic recording medium according to claim 7, wherein said magnetic film is formed in a range of thickness at 10 nm or more and less than 25 nm.
